(19) United States
(12) Patent Application Publication
(10) Pub. No.: US 2007/0030226 A1
(43) Pub. Date: Feb. 8, 2007

(54) Liquid crystal display

(75) Inventors: Jun-Woo Lee, Anyang-si (KR); Chang-Hun Lee, Yongin-si (KR); Hee-Seop Kim, Hwasung-si (KR); Eun-Hee Han, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/476,222

(22) Filed: Jun. 27, 2006

(30) Foreign Application Priority Data
Aug. 5, 2005 (KR) 10-2005-0071771

(51) Int. Cl. G09G 3/36

(52) U.S. Cl. 345/89

(57) ABSTRACT

The present invention relates to an OCB liquid crystal display, wherein a normal image data voltage and a black gray data voltage are repeatedly applied to a data line and a gate on signal of the gate line is controlled to form a pixel row (normal data pixel row) having the normal image data voltage applied thereto, a pixel row (black data pixel row) having the black gray data voltage applied thereto, and a pixel row (middle pixel row) having both of the normal image data voltage and the black gray data voltage applied thereto, and accordingly flicker is not visible, the OCB liquid crystal is not broken, and the liquid crystal display is improved in luminance.

### CROSS-REFERENCE TO RELATED APPLICATION

This application claims priority to and the benefit of Korean Patent Application No. 10-2005-0071771 filed in the Korean Intellectual Property Office on Aug. 05, 2005, the entire contents of which are incorporated herein by reference.

### BACKGROUND OF THE INVENTION

(a) Technical Field

The present disclosure relates to a liquid crystal display.

(b) Discussion of the Related Art

A liquid crystal display, which is currently one of the most popular flat panel displays, has two glass substrates in which electrodes are formed with a liquid crystal layer inserted therebetween, and the liquid crystal display varies a voltage applied to the two electrodes to vary an arrangement of liquid crystal molecules of the liquid crystal layer to thereby control an amount of transmitted light and display an image.

In the liquid crystal display, various methods have been suggested to improve a response speed and a viewing angle, and an example thereof is a liquid crystal display using an optically compensated bend (OCB) method.

The OCB liquid crystal display includes electrodes respectively formed in two facing substrates, a liquid crystal layer injected between the substrates, and alignment layers respectively formed at the two substrates for horizontally aligning liquid crystal molecules with respect to the substrate. In the OCB liquid crystal display, when an electric field is applied to the two substrates, the liquid crystal molecules are symmetric with respect to centers of the two substrates while having a structure of horizontal and vertical arrangements up to the center of the substrates. Therefore, a wide viewing angle can be obtained. In order to obtain the arrangement of the liquid crystal molecules, the alignment layers of the two substrates are processed in the same direction and a high voltage is initially applied, thereby providing a bend arrangement.

The above information disclosed in this Background section is only for enhancement of understanding of the background of the invention and, therefore, it may contain information that does not form the prior art that is already known in this country to a person of ordinary skill in the art.

### SUMMARY OF THE INVENTION

Embodiments of the present invention provide a liquid crystal display having advantages of not deteriorating display luminance, not disarranging a bend arrangement, and eliminating visible flicker. An exemplary embodiment of the present invention provides a liquid crystal display including a first insulation substrate having a plurality of pixels having switching elements connected to gate lines and data lines and a plurality of pixel electrodes to which data voltages are applied by operations of the switching elements, a second insulation substrate facing the first insulation substrate, and a liquid crystal layer injected between the first insulation substrate and the second insulation substrate and having a bend arrangement in which symmetry is formed with respect to centers of the first insulation substrate and the second insulation substrate. The plurality of pixels are arranged in a pixel matrix, and the pixel matrix includes a normal data pixel row to which a normal image data voltage for displaying an image is applied, a black data pixel row to which a black gray data voltage is applied, and a middle pixel row to which the normal image data voltage and the black gray data voltage are applied together.

The normal data pixel row, the black data pixel row, and the middle pixel row may decrease by one row every horizontal period.

The liquid crystal display may be normally white.

The normal data pixel row, the black data pixel row, and the middle pixel row may be distant from each other by as far as ⅓ of a whole pixel row.

The normal data pixel row, the black data pixel row, and the middle pixel row may be provided in the sequence of the normal data pixel row, the middle pixel row, and the black data pixel row.

A polarizer is attached to external sides of each of the first insulation substrate and the second insulation substrate. Transmissive axes of the polarizers may be at right angles with each other.

A compensation film may be attached between the first and second insulation substrates and the polarizer. The compensation film may employ a C plate compensation film or a biaxial compensation film.

An embodiment of the present invention provides a liquid crystal display including a first insulation substrate having a plurality of pixels having switching elements connected to gate lines and data lines and a plurality of pixel electrodes to which data voltages are applied by operations of the switching elements, a second insulation substrate facing the first insulation substrate, and a liquid crystal layer injected between the first insulation substrate and the second insulation substrate and having a bend arrangement in which symmetry is formed with respect to centers of the first insulation substrate and the second insulation substrate. The plurality of pixels are arranged in a pixel matrix, and the pixel matrix includes a normal data pixel row to which normal image data for displaying an image is applied, a black data pixel row to which black gray data is applied, and a middle pixel row to which the normal image data and the black gray data are applied together. The gray data displays black for a predetermined gray, and displays a predetermined luminance only for values greater than the predetermined gray.

An embodiment of the present invention provides a liquid crystal display including first and the second electrodes facing each other, and a liquid crystal layer provided between the first electrode and the second electrode and having a bend arrangement, wherein in one case a normal image data voltage representing luminance corresponding to external image information is applied to the first electrode, in another case a black gray data voltage for displaying black is applied to the first electrode, and in still another case the normal image data voltage and the black gray data voltage are applied together and are periodically and alternately generated.

### BRIEF DESCRIPTION OF THE DRAWINGS

FIG. 1 is a block diagram illustrating a liquid crystal display according to an exemplary embodiment of the present invention.

FIG. 2 is an equivalent circuit diagram for one pixel of a liquid crystal display according to an exemplary embodiment of the present invention.

FIG. 3 is a sectional view of a liquid crystal display and illustrates an arrangement state of liquid crystals according to an exemplary embodiment of the present invention.

FIG. 4 is a graph of gray versus luminance based on data when a liquid crystal display is driven according to an exemplary embodiment of the present invention.

FIG. 5 is a drawing illustrating a method for applying a signal to a gate line and a data line in a liquid crystal display according to an exemplary embodiment of the present invention.

FIG. 6 is a drawing illustrating comparison of pixel luminance applied in the method of FIG. 5.

FIG. 7 is a graph of gray versus luminance based on data when a liquid crystal display is driven according to an exemplary embodiment of the present invention.

### DESCRIPTION OF EXEMPLARY EMBODIMENTS

In an OCB liquid crystal display, there is a problem in which when the voltage drops to be at a predetermined voltage or below, a bend arrangement of the liquid crystal is disarranged.

In order to prevent disarrangement of the bend arrangement of the liquid crystal, a method for applying voltage of more than a predetermined magnitude to a pixel of the liquid crystal display is used. This method has a problem in that while the bend arrangement of the liquid crystal is not disarranged, the luminance displayed in the liquid crystal display is reduced. There is also a problem in that the liquid crystal display generates flicker.

An embodiment of the present invention provides an OCB liquid crystal display and a driving method thereof, in which the display luminance is not deteriorated, the bend arrangement is not disarranged, and the flicker is not visible.

In order to achieve the above solution, in the OCB liquid crystal display according to an embodiment of the present invention, a normal image data voltage and a black gray data voltage are repeatedly applied to a data line, and a gate-on signal of the gate line is controlled to thereby selectively form a first pixel row, that is, a normal data pixel row, having the normal image data voltage applied thereto, a second pixel row, that is, a black data pixel row, having the black gray data voltage applied thereto, and a third pixel row, that is, a middle pixel row, having both of the normal image data voltage and the black gray data voltage applied thereto.

With reference to the accompanying drawings, embodiments of the present invention will be described in order for those skilled in the art to be able to implement the invention. As those skilled in the art would realize, the described embodiments may be modified in various different ways, all without departing from the spirit or scope of the present invention.

To clarify multiple layers and regions, the thicknesses of the layers are enlarged in the drawings. Like reference numerals designate like elements throughout the specification. When it is said that any part, such as a layer, film, area, or plate is positioned on another part, it means the part is directly on the other part or above the other part with at least one intermediate part. On the other hand, if any part is said to be positioned directly on another part it means that there is no intermediate part between the two parts.

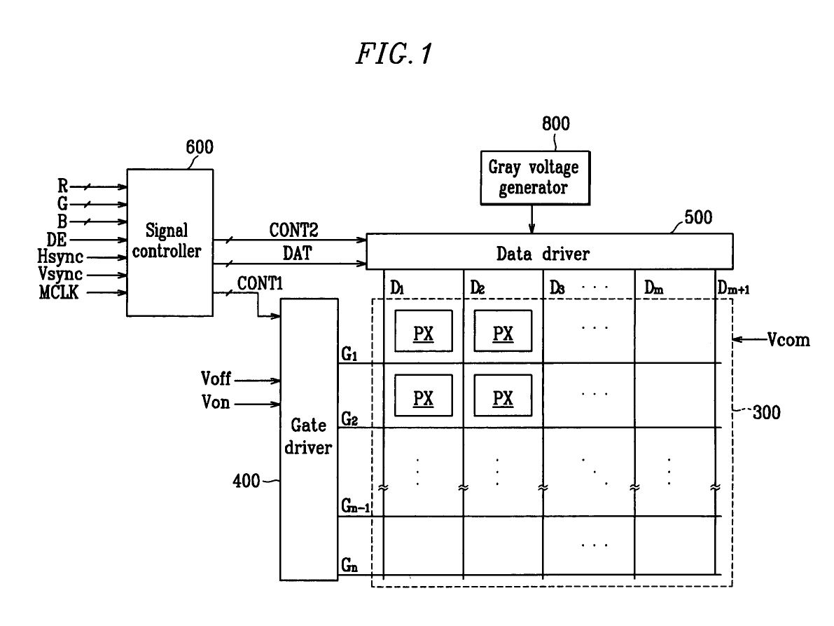

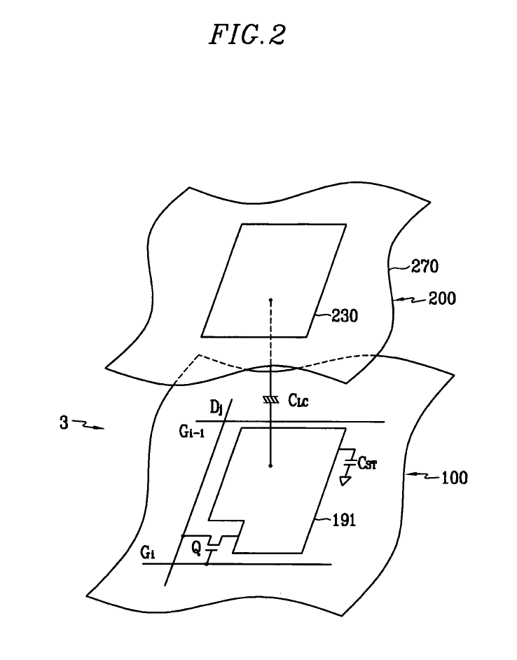

First, a liquid crystal display according to an exemplary embodiment of the present invention will be described with reference to FIG. 1 and FIG. 2.

FIG. 1 is a block diagram illustrating a liquid crystal display according to an exemplary embodiment of the present invention, and FIG. 2 is an equivalent circuit diagram illustrating one pixel of a liquid crystal display according to an exemplary embodiment of the present invention.

As shown in FIG. 1, the liquid crystal display according to an exemplary embodiment of the present invention includes a liquid crystal panel assembly 300, a gate driver 400 and a data driver 500 connected thereto, a gray voltage generator 800 connected to the data driver 500, and a signal controller 600 for controlling the gate driver 400 and the data driver 500.

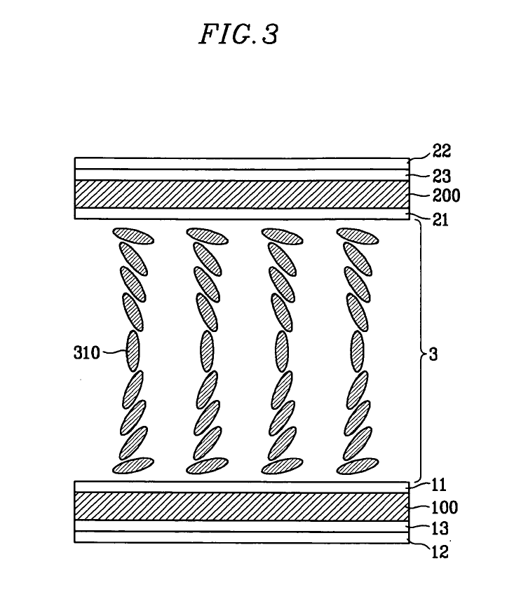

In an equivalent circuit, the liquid crystal panel assembly, 300 includes a plurality of display signal lines (Gₗ-Gₙ, Dₗ-Dₘ) and a plurality of pixels (PX) connected to the plurality of display signal lines and appropriately arranged in a matrix. More specifically, in a structure shown in FIG. 2, the liquid crystal panel assembly 300 includes lower and upper panels 100 and 200 facing each other, and a liquid crystal layer interposed therebetween as represented at 3. The liquid crystal layer 3 includes an optically compensated bend (OCB) liquid crystal having a bend arrangement in symmetry with an imaginary center surface between the lower and upper panels 100 and 200, as shown in FIG. 3.

The signal lines (Gₗ-Gₙ, Dₗ-Dₘ) include a plurality of gate lines (Gₗ-Gₙ) for transmitting a gate signal, also referred to as “scanning signal”, and a plurality of data lines (Dₗ-Dₘ) for transmitting a data signal. The gate lines (Gₗ-Gₙ) are arranged approximately in a row direction and are generally in parallel with each other, and the data lines (Dₗ-Dₘ) are arrayed approximately in a column direction and are generally parallel with each other.

Each pixel PX, for example, the pixel PX connected to an i-th (i=1, 2, . . . , n) gate line(Gi) and a j-th (j=1, 2, . . . , m) data line (Dj), includes a switching element Q connected to a signal line (Gi, Dj), and a liquid crystal capacitor C_{lc} and a storage capacitor Cₛₜ connected to the switching element Q. The storage capacitor Cₛₜ can be omitted according to need.

The switching element Q is a three terminal elements such as a thin film transistor, provided on the lower panel 100 and has a control terminal connected with the gate line (Gₗ-Gₙ), an input terminal connected with the data line (Dₗ-Dₘ), and an output terminal connected with the liquid crystal capacitor C_{lc} and the storage capacitor Cₛₜ.

In the liquid crystal capacitor C_{lc}, a pixel electrode 191 of the lower panel 100 and a common electrode 270 of the upper panel 200 are used as two terminals, and the liquid crystal layer 3 between the two electrodes 191 and 270 serves as a dielectric material. The pixel electrode 191 is connected with the switching element Q, and the common electrode 270 is formed in front of the upper panel 200 and receives a common voltage (Vcom). Unlike as shown in FIG. 2, the common electrode 270 can also be provided on the lower panel 100, and at least one of the two electrodes 191 and 270 can be formed in a line type or a bar type.

The storage capacitor Cₛₜ serving as a subsidiary unit of the liquid crystal capacitor C_{lc} is formed by overlapping an insulator between a separate signal line (not shown) provided for the lower panel 100, and the pixel electrode 191. A voltage, such as a common voltage (Vcom), is applied to the separate signal line. However, the storage capacitor Cₛₜ can also be formed by overlapping the pixel electrode 191 with a previous gate line provided directly thereon, with an insulator interposed therebetween.

In order to display color, each pixel PX inherently displays one of the primary colors, that is, spatial division, or each pixel PX alternately displays the primary colors depending on the passage of time, that is, temporal division, so that a desired color is recognized by a spatial or temporal sum of the primary colors. The primary colors can be exemplified as the three primary colors red, green, and blue. FIG. 2 is an example of the spatial division, and shows that each pixel PX includes a color filter 230 for displaying one of the primary colors in a region of the upper panel 200 corresponding to the pixel electrode 191. Unlike as shown in FIG. 2, the color filter 230 can be also formed on or under the pixel electrode 191 of the lower panel 100.

The liquid crystal display can also include a backlight unit (not shown) for supplying light to the display panels 100 and 200 and the liquid crystal layer 3.

As shown in FIG. 3, polarizers 12 and 22 are provided outside of the display panels 100 and 200. It is desirable that the light transmissive axes of the polarizers 12 and 22 are at right angles to each other.

Compensation films 13 and 23 can be attached between the polarizers 12 and 22 and the display panels 100 and 200, and C plate compensation films or biaxial compensation films are used as the compensation films 13 and 23.

The liquid crystal layer 3 includes a nematic liquid crystal having positive dielectric anisotropy, and is aligned in an optically compensated bend (OCB) method and has a bend arrangement as shown in FIG. 3. In general, the OCB liquid crystal normally displays white, that is, the display is white in a state where no voltage is applied.

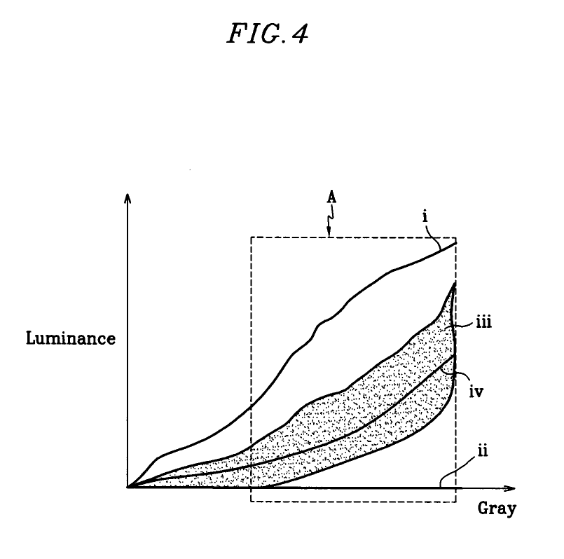

Referring again to FIG. 1, the gray voltage generator 800 generates two gray voltage sets relating to the transmittance of the pixels. The two gray voltage sets are generated based on gamma curves that are different from each other. This will be described in detail later with reference to FIG. 4.

The gate driver 400 is connected with the gate lines (Gₗ-Gₘ) of the liquid crystal panel assembly 300, and applies a gate signal which is a combination of a gate-on voltage (Von) and a gate-off voltage (Voff) to the gate lines (Gₗ-Gₙ).

The data driver 500 is connected with the data lines (Dₗ-Dₘ) of the liquid crystal panel assembly 300, and selects a gray voltage from the gray voltage generator 800 and applies the selected gray voltage to the data lines (Dₗ-Dₘ) as the data signal. However, in a case where the gray voltage generator 800 does not provide gray voltages for all grays but provides only a predetermined number of reference gray voltages, the data driver 500 divides the reference gray voltages, generates the gray voltages for all grays, and selects the data signal from the generated gray voltages.

The signal controller 600 controls the gate driver 400 and the data driver 500.

Each of the units 400, 500, 600, and 800 can be directly mounted on the liquid crystal panel assembly 300 in the form of at least one IC chip, can be mounted on a flexible printed circuit film (not shown) and attached to the liquid crystal panel assembly 300 in a form of tape carrier package (TCP), or can be mounted on a separate printed circuit board (PCB) (not shown). Alternately, the units 400, 500, 600, and 800 can be integrated with the liquid crystal panel assembly 300 together with the signal lines (Gₗ-Gₙ, Dₗ-Dₘ), the thin film transistor switching element Q, and the like. The drivers 400, 500, 600, and 800 can be integrated as a single chip. In this case, at least one driver, or at least one circuit element constituting the driver, can be provided outside of the single chip.

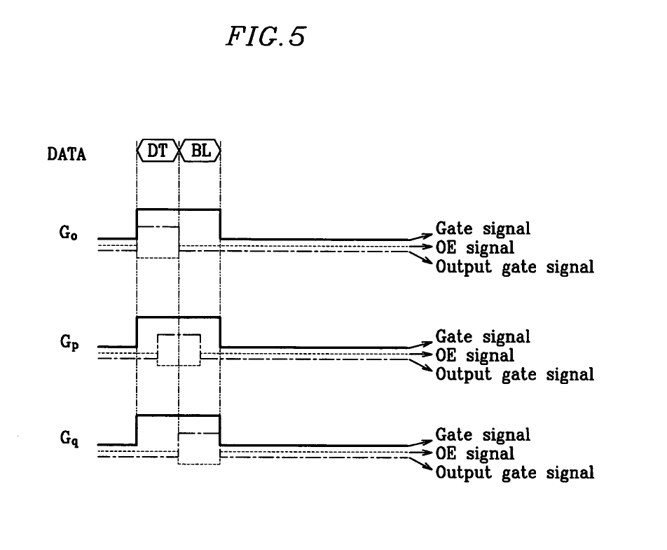

Operation of the liquid crystal display will be described in detail with reference to FIG. 4 and FIG. 5.

FIG. 4 is a graph of gray versus luminance based on data when the liquid crystal display is driven according to an exemplary embodiment of the present invention, and FIG. 5 shows waveforms used in applying the signal to the gate line and the data line in the liquid crystal display according to an exemplary embodiment of the present invention.

The signal controller 600 receives input image signals R, G, and B and input control signals for controlling display thereof from an external graphic controller (not shown). The input image signals R, G, and B have luminance information of each pixel, and the luminance has a predetermined number of grays, for example, 1024(=2¹⁰), 256(=2⁸), or 64(=2⁶) grays. Examples of the input control signals are a vertical synchronization signal (Vsync), a horizontal synchronizing signal (Hsync), a main clock signal (MCLK), and a data enable signal (DE).

On the basis of the input control signals, the signal controller 600 suitably processes the input image signals R, G, and B so as to be suitable for the operating conditions of the liquid crystal panel assembly 300 and the data driver 500. Then, after generating a gate control signal (CONT1) and a data control signal (CONT2), the signal controller 600 transmits the gate control signal (CONT1) to the gate driver 400 and transmits an image signal (DAT) and the processed data control signal (CONT2) to the data driver 500.

The gate control signal (CONT1) includes a scanning start signal (STV) for instructing a scanning start, and at least one clock signal for controlling an output period of a gate-on voltage (Von). The gate control signal CONT1 can also include an output enable signal (OE) for defining a sustain time of the gate-on voltage (Von).

The data control signal (CONT2) includes a horizontal synchronization start signal (STH) for setting a transmission start of the image data for one-row pixels, and a load signal (LOAD) and a data clock signal (HCLK) for applying the data signal to the data lines (Dₗ-Dₘ). The data control signal (CONT2) can further include an inversion signal (RVS) for inverting a voltage polarity, hereinafter, referred to as “data signal polarity”, of the data signal for the common voltage (Vcom).

Referring to FIG. 5, the image signal (DAT) that is transmitted to the data driver 500 from the signal controller 600 includes normal image data (DT) and black gray data (BL). In FIG. 4, a curve (i) is a luminance curve (gamma curve) of the normal image data (DT), and a curve (ii) is a luminance curve of the black gray data (BL). The curve (ii) is of data displaying black for all grays. In the image signal (DAT), the normal image data (DT) and the black gray data (BL) are alternately repeated.

In response to the data control signal (CONT2) from the signal controller 600, the data driver 500 receives and converts the normal image data (DT) and the black gray data (BL) into a normal analog data voltage and a black gray analog data voltage, respectively. The normal analog data voltage is preferably selected from the two gray voltage sets from the gray voltage generator 800 that satisfy the curve (i) of FIG. 4, and the black gray data voltage is preferably selected from the two gray voltage sets that satisfy the curve (ii).

Next, the data driver 500 applies the normal data voltage and the black gray data voltage to the data lines (Dₗ-Dₘ).

The gate driver 400 concurrently applies the gate-on voltage (Von) of the gate signal to three arbitrary gate lines (Gₒ, Gₚ, G_{q}) of the gate lines (Gₗ-Gₙ) depending on the gate control signal (CONT1) of the signal controller 600, and controls an OE signal, thereby controlling the output gate signal applied to the three gate lines. In the present exemplary embodiment, when the OE signal is of a low voltage, the gate signal is outputted. As shown in FIG. 5, gate-on times of the Gₒ and G_{q} gate lines of the three gate lines (Gₒ, Gₚ, G_{q}) are not overlapped with each other, but a gate-on time of the Gₚ gate line is overlapped with the gate-on times of the Gₒ and G_{q} gate lines. Here, the gate-on time of the Gₚ gate line and the gate-on times of the Gₒ and G_{q} gate lines can be varied.

During the gate-on time of the Gₒ gate line, the normal image data voltage is applied to the data line (Dₗ-Dₘ), and, during the gate-on time of the G_{q} gate line, the black gray data voltage is applied to the data line (Dₗ-Dₘ). During the gate-on time of the Gₚ gate line, the normal image data voltage and the black gray data voltage are both applied to the data lines (Dₗ-Dₘ).

Here, “o”, “p”, and “q” have arbitrary values that are different from each other.

As described above, if the switching element (Q) that is connected to the gate lines (Gₗ-Gₙ) turns on by applying the gate-on voltage (Von) to the gate lines (Gₗ-Gₙ) depending on the gate control signal (CONT1), the data signal applied to the data lines (Dₗ-Dₘ) is applied to the pixel PX through the turned-on switching element Q.

A difference between the voltage of the data signal applied to the pixel PX and the common voltage (Vcom) is represented as a charge voltage of the liquid crystal capacitor C_{lc}, that is, a pixel voltage. Liquid crystal molecules are different in alignment depending on a level of the pixel voltage, and accordingly polarization of the light passing through the liquid crystal layer 3 varies. The polarization variation is represented as a transmittance variation of light by the polarizers 12 and 22 of the display panel assembly 300.

By repeating the above process in each horizontal period, which is referred to as “1H” and is the same as one period of the horizontal synchronizing signal (Hsync) and the data enable signal (DE)), the gate-on voltage (Von) is sequentially applied to all gate lines (Gₗ-Gₙ) and the data signal is applied to all pixels PX, thereby displaying the image of one frame.

The inversion signal (RVS) that is applied to the data driver 500 is controlled such that when one frame ends, a next frame starts, and the data signal applied to each pixel PX has a polarity that is opposite to a polarity of the previous frame, thereby providing “frame inversion”. In one frame, the data signal flowing through one data line changes in polarity depending on a characteristic of the inversion signal (RVS), for example, row inversion and dot inversion, or the data signals applied to one pixel row can be different in polarity from each other, for example, column inversion and dot inversion.

Hereinafter, a pixel row having the normal image data voltage applied thereto, such as a pixel row connected to the Gₒ gate line, is called a normal data pixel row, a pixel row having the black gray data voltage applied thereto, such as a pixel row connected to the G_{q} gate line, is called a black data pixel row, and a pixel row having the normal image data voltage and the black gray data voltage applied thereto, such as a pixel row connected to the Gₚ gate line, is called a middle pixel row.

The graph of FIG. 4 will be described in more detail below.

FIG. 4 illustrates curves of luminance versus gray. FIG. 4 illustrates three curves (i, ii, and iv) and one region (iii). The (i) and (ii) curves show luminance in which the normal data pixel row and the black data pixel row display depending on gray, the (iii) region shows luminance in which the middle pixel row displays depending on gray, and the middle pixel row shows luminance along an arbitrary curve of the (iii) region according to an exemplary embodiment of the present invention. Meantime, the (iv) curve shows a preferable luminance that a display device displays depending on gray. It is desirable that, even though the data signal is applied to each pixel along an arbitrary curve of the (i) and (ii) curves and the (iii) region, the whole liquid crystal display is formed to follow the (iv) curve.

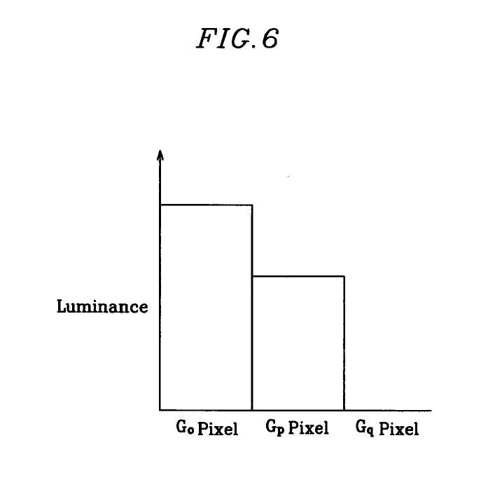

FIG. 6 is a drawing illustrating a comparison of the pixel luminance applied in the method of FIG. 5.

The normal data pixel row is high in luminance but the black data pixel row is low in luminance. The middle pixel row has a middle luminance between the normal data pixel row and the black data pixel row.

As shown in FIG. 4, since the (i) and (ii) curves have a great luminance difference in an “A” region, in the case where only the normal data pixel row and the black data pixel row are disposed, flicker is in danger of being visible. However, if the middle pixel row is formed, the middle pixel row compensates for the luminance difference as in FIG. 6, and therefore the flicker is not visible.

The bend arrangement of the OCB liquid crystal is disarranged when a voltage lower than a voltage, hereinafter, referred to as “threshold voltage (Vc)”, for disarranging the bend arrangement is applied for a time of 500 ms or longer. However, if the black gray data voltage having a high voltage is applied every one horizontal period (1H), the bend arrangement of the OCB liquid crystal is not disarranged.

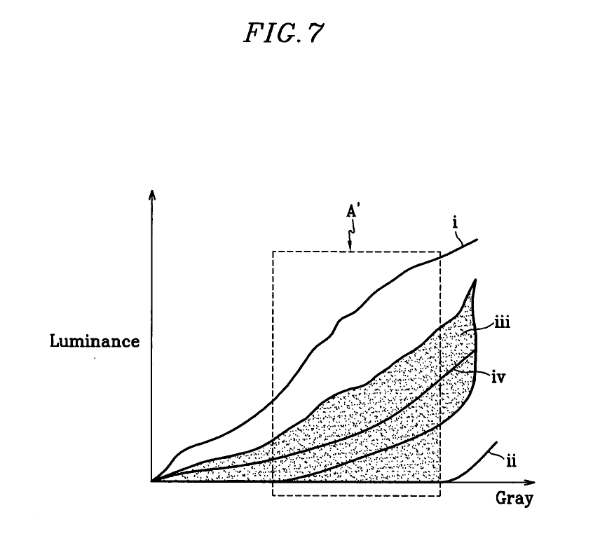

FIG. 7 is a graph of luminance versus gray based on data when the liquid crystal display is driven according to an embodiment of the present invention.

The (ii) curve of FIG. 7 is different from that of FIG. 4. In the (ii) curve of FIG. 7, black is not displayed at the right high gray region of the A′ region. In other words, black is displayed at a predetermined gray or less but a specific luminance is displayed at more than the predetermined gray. Accordingly, the luminance can be displayed at the high gray of the (ii) curve, thereby improving the whole luminance of the liquid crystal display and reducing the flicker caused by the luminance difference between the (i) and (ii) curves at the right high gray region of the A′ region.

In the (ii) curve, the luminance displayed at the right high gray of the A′ region can be variously provided, but it is desirable that the luminance is displayed to be lower than the luminance of the (i) curve.

In the above exemplary embodiment, the o, p, and q can be variously combined, and depending on the combinations thereof, a ratio of the black data pixel row, the normal data pixel row, and the middle pixel row is determined. Most simply, the whole pixel row is divided into three equal parts and the o, p, and q are provided at intervals ⅓ of a pixel row. It is desirable that the pixel row is disposed in a sequence of o, q, and p.

Meantime, it is desirable that the o, p, and q are determined in consideration of the luminance and flicker elimination of the whole liquid crystal display. In considering the luminance, it is desirable that a ratio of black data pixel rows to all the pixel rows is about 0.5 or less.

An on, period of the gate line of the middle pixel row is controlled using the OE signal so that the normal image data voltage that is more or less than the black gray data voltage can be applied to the middle pixel row. The gate-on time of the middle pixel row can also be decreased or increased, and it is desirable that the gate-on time is within a time for which the gate line of the black data pixel row is off after the gate line of the normal data pixel row is on.

As described above, in the OCB liquid crystal display, the normal image data voltage and the black gray data voltage are repeatedly applied to the data line and the gate-on signal of the gate line is controlled, thereby forming the pixel row (normal data pixel row) having the normal image data voltage applied thereto, the pixel row (black data pixel row) having the black gray data voltage applied thereto, and the pixel row (middle pixel row) having both of the normal image data voltage and the black gray data voltage applied thereto, and accordingly the flicker is not visible, the OCB liquid crystal is not broken, and the liquid crystal display is improved in luminance.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first insulation substrate forming a plurality of pixels and having switching elements connected to gate lines and data lines, and a plurality of pixel electrodes to which data voltages are applied by operations of the switching elements;
a second insulation substrate facing the first insulation substrate; and
a liquid crystal layer injected between the first insulation substrate and the second insulation substrate, and having a bend arrangement in which symmetry is formed with respect to a center area between the first insulation substrate and the second insulation substrate,
wherein the plurality of pixels are arranged in a pixel matrix, and
wherein the pixel matrix includes a normal data pixel row to which a normal image data voltage for displaying an image is applied, a black data pixel row to which a black gray data voltage is applied, and a middle pixel row to which the normal image data voltage and the black gray data voltage are applied together.

2. The display of claim 1, wherein the normal data pixel row, the black data pixel row, and the middle pixel row decrease by one row every one horizontal period.

3. The display of claim 1, wherein the liquid crystal display is normally in a white mode.

4. The display of claim 1, wherein the normal data pixel row, the black data pixel row, and the middle pixel row are distant from each other by as far as ⅓ of a whole pixel row.

5. The display of claim 4, wherein the normal data pixel row, the black data pixel row, and the middle pixel row are provided in a sequence of the normal data pixel row, the middle pixel row, and the black data pixel row.

6. The display of claim 1, wherein a polarizer is attached to each external side of the first insulation substrate and the second insulation substrate.

7. The display of claim 6, wherein transmissive axes of each polarizer are at right angles with each other.

8. The display of claim 6, wherein a compensation film is attached between the first and second insulation substrates and the polarizer attached to the external sides thereof.

9. The display of claim 8, wherein the compensation film employs one of a C plate compensation film and a biaxial compensation film.

10. A liquid crystal display comprising:
a first insulation substrate forming a plurality of pixels and having switching elements connected to gate lines and data lines, and a plurality of pixel electrodes to which data voltages are applied by operations of the switching elements;
a second insulation substrate facing the first insulation substrate; and
a liquid crystal layer injected between the first insulation substrate and the second insulation substrate, and having a bend arrangement in which symmetry is formed with respect to a center area between the first insulation substrate and the second insulation substrate,
wherein the plurality of pixels are arranged in a pixel matrix,
wherein the pixel matrix includes a normal data pixel row to which normal image data for displaying an image is applied, a black data pixel row to which black gray data is applied, and a middle pixel row to which the normal image data and the black gray data are applied together, and
wherein the gray data displays black for a predetermined gray, and displays predetermined luminance only for more than the predetermined gray.

11. A liquid crystal display comprising:
first and second electrodes facing each other; and
a liquid crystal layer provided between the first electrode and the second electrode, and having a bend arrangement,
wherein a case where a normal image data voltage representing luminance corresponding to external image information is applied to the first electrode, a case where a black gray data voltage for displaying black is applied to the first electrode, and a case where the normal image data voltage and the black gray data voltage are applied to the first electrode together and are periodically and alternately generated.

12. A liquid crystal display comprising:
a first insulation substrate having a plurality of pixels having switching elements connected to gate lines and data lines, and a plurality of pixel electrodes to which data voltages are applied by operations of the switching elements;
a second insulation substrate facing the first insulation substrate; and
a liquid crystal layer injected between the first insulation substrate and the second insulation substrate,
wherein the plurality of pixels are arranged in a pixel matrix, and
wherein the pixel matrix includes a normal data pixel row to which a normal image data voltage for displaying an image is applied, a gray data pixel row to which a gray data voltage is applied, and a middle pixel row to which the normal image data voltage and the gray data voltage are applied together.

13. The display of claim 12, wherein the gray data displays black for a predetermined gray, and displays predetermined luminance only for more than the predetermined gray.
